(19) United States
(12) Patent Application Publication
(10) Pub. No.: US 2009/0020958 A1
(43) Pub. Date: Jan. 22, 2009

(54) METHODS AND APPARATUS FOR OPERATING AN INTERNAL COMBUSTION ENGINE

(76) Inventor: David F. Soul, Olney (GB)

Correspondence Address: PATRICK W. RASCHE;ARMSTRONG TEASDALE LLP, ONE METROPOLITAN SQUARE, SUITE 2600, ST. LOUIS, MO, 63102-2740, US

(21) Appl. No.: 11/278,320

(22) Filed: Mar. 31, 2006

(51) Int. Cl. F16J 9/00

(52) U.S. Cl. 277/434

(57) ABSTRACT

A piston ring assembly for an internal combustion engine is provided. The piston ring assembly includes a plurality of seal rings, i.e., a first seal ring and a second seal ring. The seal rings are positioned on at least a portion of a piston crown periphery axially and radially adjacent to each other within the internal combustion engine and at least a portion of the first seal ring at least partially extends over at least a portion of the second seal ring.

### BACKGROUND OF THE INVENTION

This invention relates generally to internal combustion engines and, more particularly, to methods and apparatus for cooling diesel engine cylinders.

At least some known internal combustion engines include a crankcase having at least one cylinder liner and at least one bank of cylinders extending within the crankcase. Some opposed-piston engines include two opposed pistons within each cylinder liner that move relative to the cylinder liner between inner and outer dead center. One potential benefit of this type of engine is that the power-to-weight ratio of the engine may be increased, thereby facilitating operation of the engine in applications that are best served with light-weight power sources.

In operation, as the pistons approach each other, combustion of fuel and air is facilitated and high temperature combustion products are generated. As the pistons move relative to the cylinder liner, friction exists between at least a portion of the cylinder liners and pistons that generates heat. The heat generated by combustion and this friction may facilitate subsequent component wear. At least some known internal combustion engines use fluid-based methods to facilitate heat removal from the pistons. However, some engines use a closed-loop fluid-based cooling method wherein predetermined heat removal profiles may not be facilitated.

### BRIEF DESCRIPTION OF THE INVENTION

In one aspect, a piston ring assembly for an internal combustion engine is provided. The piston ring assembly includes a plurality of seal rings positioned on at least a portion of a piston crown periphery.

In another aspect, a method of operating an internal combustion engine is provided. The method includes positioning a piston ring assembly on at least a portion of a piston crown periphery. The positioning a piston ring assembly comprises positioning a first seal ring and a second seal ring such that the first seal ring is a first axial distance from the combustion chamber and the second seal ring is a second axial distance from the combustion chamber. The second distance is greater than the first distance and the first seal ring comprising a high temperature material.

In a further aspect, an internal combustion engine is provided. The engine includes at least one substantially cylindrical housing and a plurality of opposed piston assemblies enclosed within the at least one cylindrical housing. The plurality of opposed piston assemblies includes a plurality of seal rings positioned on at least a portion of a piston crown periphery.

### BRIEF DESCRIPTION OF THE DRAWINGS

FIG. 1 is a schematic overhead view of an exemplary internal combustion engine;

FIG. 2 is a cross-sectional schematic overhead view of the exemplary internal combustion engine shown in FIG. 1;

FIG. 3 is a cross-sectional schematic view of an exemplary piston assembly that may be used with the internal combustion engine shown in FIG. 1;

FIG. 4 is an expanded cross-sectional schematic view of an exemplary piston ring assembly taken along area 4 shown in FIG. 3 that may be used with the internal combustion engine shown in FIG. 1;

FIG. 5 is a cross-sectional schematic overhead view of an exemplary fire ring that may be used with the piston ring assembly shown in FIG. 4;

FIG. 6 is a cross-sectional schematic side view of the exemplary fire ring that may be used with the piston ring assembly shown in FIG. 4;

FIG. 7 is a cross-sectional schematic side view of an exemplary slit that may be defined within the fire ring shown in FIG. 6;

FIG. 8 is an expanded cross-sectional schematic view of the fire ring taken along area 8 shown in FIG. 7 that may be used with the piston ring assembly shown in FIG. 4;

FIG. 9 is a cross-sectional schematic overhead view of an exemplary seal ring that may be used with the piston ring assembly shown in FIG. 4;

FIG. 10 is a cross-sectional schematic side view of the exemplary seal ring that may be used with the piston ring assembly shown in FIG. 4;

FIG. 11 is a cross-sectional schematic side view of an exemplary slit that may be defined within the seal ring shown in FIG. 10; and

FIG. 12 is an expanded cross-sectional schematic view of the seal ring taken along area 12 shown in FIG. 11 that may be used with the piston ring assembly shown in FIG. 4.

### DETAILED DESCRIPTION OF THE INVENTION

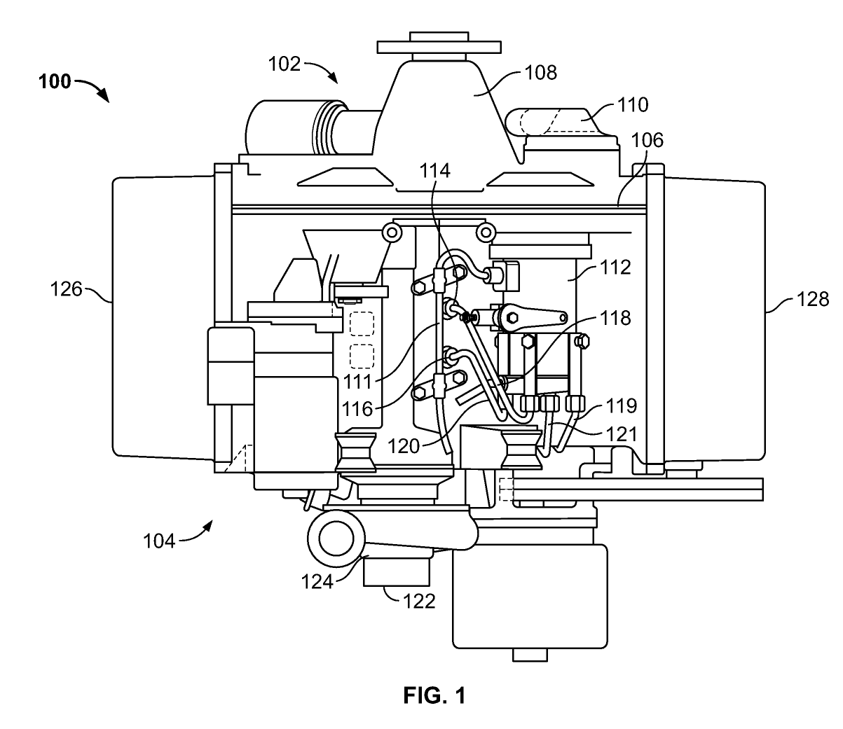

FIG. 1 is a schematic overhead view of an exemplary internal combustion engine 100. In the exemplary embodiment, engine 100 is a water-cooled, compression ignition, twin cylinder, two-stroke, uniflow, opposed-piston diesel engine. For example, engine 100 may be, but is not limited to a PowerLite-100 model diesel engine commercially available from Dieseltech, LLC of Orangeburg, S.C. Alternatively, engine 100 may be any engine in which the embodiments described herein may be embedded. Engine 100 may be used in applications that include, but are not limited to, manned aircraft, unmanned air vehicles (UAV's), marine, electrical power generation, industrial machinery and automotive hybrid engines and generators.

Engine 100 includes a gear case 102 and a crankcase 104 removably coupled together at interface 106 via retention hardware (not shown in FIG. 1) that may include, but not be limited to nuts and bolts. Gear case 102 and crankcase 104 may be fabricated via methods that include, but are not limited to casting. Gear case 102 includes a drive assembly 108 rotatingly coupled to a gear train (not shown in FIG. 1). Gear case 102 also includes a water pump 110 that facilitates forced cooling of at least some of engine 100 components and an oil pump (not shown in FIG. 1) that facilitates forced cooling and lubricating oil flow (as described further below). Positioned external to and on top of crankcase 104 is a fuel injector pump 112 coupled in flow communication to a fuel source (not shown in FIG. 1) via a fuel supply pipe 111. Pump 112 is also coupled in flow communication with and supplies fuel to a first injector 114 and a second injector 116 via fuel pipes 118 and 120, respectively, wherein fuel pipes 118 and 120 are external to crankcase 104. Pump 112 is also coupled in flow communication with and supplies fuel to two fuel injectors positioned on the bottom of engine 100 (not shown in FIG. 1) via fuels pipes 119 and 121 wherein the two fuel injectors are substantially opposed to injectors 114 and 116.

Crankcase 104 includes an air intake 122 coupled in flow communication to a compressor 124, or supercharger, for compressing air used in combustion. Alternatively, engine 100 may be fabricated without supercharger 124. Crankcase 104 also includes a plurality of crankcase end covers mounted outboard on either side of engine 100. Specifically, side cover 126 and side cover 128 are positioned on the left hand side and right hand side of engine 100, respectively. Covers 126 and 128 each house a half-length crankshaft, i.e., a left hand side crankshaft and a right hand side crankshaft (neither illustrated in FIG. 1). The two crankshafts are movably coupled to piston assemblies (not shown in FIG. 1 and described further below) and are synchronized to the gear train. Moreover, the two crankshafts are supported by a plurality of bearings (not shown in FIG. 1) within crankcase 104.

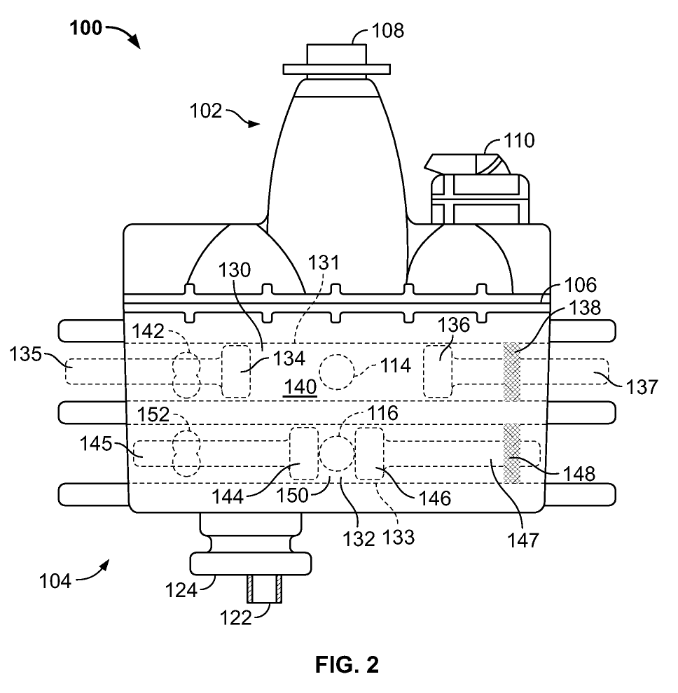

FIG. 2 is a cross-sectional schematic overhead view of exemplary internal combustion engine 100 wherein a plurality of components illustrated in FIG. 1 are illustrated for reference and perspective. In the exemplary embodiment, engine 100 is a two-cylinder engine, i.e., crankcase 104 further includes a first cylinder 130 and a second cylinder 132, each having a substantially cylindrical cylinder wall 131 and 133, respectively. Alternatively, engine 100 may be a three-cylinder or four-cylinder engine or may include any number of cylinders. Cylinders 130 and 132 are positioned substantially horizontally and are substantially independent of each other. Cylinder 130 houses and defines a bore for two opposing piston assemblies, specifically a left hand side piston assembly 134 and a right hand side piston assembly 136. Piston assemblies 134 and 136 are discussed further below. In the exemplary embodiment, cylinder wall 131 is fabricated of steel. Alternatively, wall 131 is fabricated of any material that attains predetermined operating parameters of engine 100 such as, but not limited to, mitigating deformation of wall 131 and wear between pistons 134 and 136 and wall 131 during operation. Piston assemblies 134 and 136 include connecting rods 135 and 137 movably coupled to the left hand side and right hand side crankshafts (neither shown in FIG. 2), respectively. Piston assemblies 134 and 136 are illustrated between an outer and an inner dead center position (described further below). Cylinder air inlet ports 138 are positioned on the right hand side of cylinder 130 and are coupled in flow communication with supercharger 124 and a combustion chamber 140 defined by cylinder wall 131. Inlet ports 138 are substantially tangential with respect to cylinder wall 131. Cylinder exhaust ports 142 are coupled in flow communication with combustion chamber 140 and an exhaust manifold (not shown in FIG. 2).

Cylinder 132 is substantially similar to cylinder 130 and houses and defines a bore for a left hand side piston assembly 144 and a right hand side piston assembly 146. Piston assemblies 144 and 146 include connecting rods 145 and 147, respectively and rods 145 and 147 are movably coupled to the left hand side and right hand side crankshafts, respectively. Piston assemblies 144 and 146 are discussed further below. In the exemplary embodiment, cylinder wall 141 is fabricated of stainless steel. Alternatively, wall 141 is fabricated of any material that attains predetermined operating parameters of engine 100 such as, but not limited to mitigating deformation of wall 141 and wear between pistons 144 and 146 and wall 141 during operation. Piston assemblies 144 and 146 are illustrated in the inner dead center position (described further below). Cylinder air inlet ports 148 are positioned on the right hand side of cylinder 132 and are coupled in flow communication with supercharger 124 and a combustion chamber 150 defined by cylinder wall 133. Inlet ports 148 are substantially tangential with respect to cylinder wall 133. Cylinder exhaust ports 152 are coupled in flow communication with combustion chamber 150 and the exhaust manifold.

FIGS. 1 and 2 are referenced for the operational discussion. In operation, air is pulled into engine 100 via air intake 122 and compressed to a higher density at a higher pressure by supercharger 124. Alternative embodiments of engine 100 may operate similarly without supercharger 124. Pressurized air is channeled to air inlets 138 and 148 via a manifold (not shown in FIG. 2). As air is channeled into cylinders 130 and 132 via tangential inlet ports 138 and 148, respectively, a swirling motion is generated which facilitates combustion and scavenging. Also, in operation, fuel is received from the fuel source via pipe 111 and fuel pump 112 increases the fuel pressure for subsequent channeling to injectors 114 and 116 via pipes 118 and 120, respectively. Fuel is also channeled to the pair of injectors on the bottom of engine 100 via pipes 119 and 121. Fuel is pumped at a predetermined rate that is based on parameters including, but not limited to, a speed of engine 100. In the exemplary embodiment, the fuel used in engine 100 is number 2 diesel fuel. Alternatively, the fuel is another fuel such as, but is not limited to, Jet A and JP-8 (aircraft fuels), propane and bio-fuel derivatives.

Fuel and air are channeled into cylinders 130 and 132 while piston assemblies 134, 136, 144 and 146 and associated connecting rods 135, 137, 145 and 147, respectively are in motion. FIG. 2 illustrates piston assemblies 134 and 136 in first cylinder 130 moving toward the inner dead center position from the outer dead center position. FIG. 2 also illustrates piston assemblies 144 and 146 in second cylinder 132 at the inner dead center position.

“Dead center” is a term that typically describes a position of a moving crank and associated connecting rod when they are positioned in a line with each other at the furthermost end of each stroke and the piston and connecting rod are not exerting torque. “Outer dead center”, or ODC typically describes a point in the cylinder stroke cycle wherein the piston assemblies are at their furthermost distance from each other. “Inner dead center”, or IDC typically describes a point in the cylinder stroke wherein the piston assemblies are at the smallest distance from each other and the combustion space between the piston assemblies is at a minimum. In the exemplary embodiment, at IDC, the left hand side and right hand side crankshafts are configured to be phased such that there is an approximately 12° difference between the two crankshafts. Specifically, when piston assemblies 134 and 144 are considered to be at IDC, the left hand side crankshaft is approximately 6° past the associated dead center point, i.e., assemblies 134 and 144 are traveling toward the associated ODC position. Moreover, when piston assemblies 136 and 146 are considered to be at IDC, the right hand crankshaft is approximately 6° before the associated dead center point, i.e., assemblies 136 and 146 are traveling toward the associated IDC position. Alternatively, a phasing range of 10° to 15° between the two crankshafts may be used to facilitate the operation of engine 100. The purposes of this configuration include mitigating any contact potential for piston assemblies 134 and 136 and assemblies 144 and 146 as well as facilitating “scavenging” as discussed further below.

As piston assemblies 134 and 136 begin their travel from the ODC position toward the IDC position (typically referred to as the inward stroke of the two-stroke method) air is channeled into cylinder 130 via open port 138 and combustion exhaust gases are channeled from cylinder 130 via ports 142. Air at a higher pressure that is introduced into cylinder 130 facilitates channeling exhaust gases at a lower pressure from cylinder 130. This portion of a compressed ignition method is typically referred to as scavenging. As piston assembly 136 moves toward piston 134, air inlet ports 138 are covered by piston assembly 136 while exhaust ports 142 are uncovered, thereby facilitating additional scavenging action. As piston assembly 134 moves toward piston assembly 136, exhaust port 142 is covered thereby substantially reducing exhaust gas flow. The tolerances between piston assemblies 134 and 136 and cylinder wall 131 are small thereby facilitating air pressurization within cylinder 130 between piston assemblies 134 and 136 as piston assemblies 134 and 136 approach each other. As air pressure in cylinder 130 increases, the associated air temperature increases as well. Once piston assemblies 134 and 136 are at a predetermined distance from each other, i.e., piston assemblies 134 and 136 are substantially close to IDC, fuel injector 114 and the associated injector on the bottom side of engine 100 opposite injector 114 channels a predetermined amount of fuel for a predetermined rate of time into cylinder 130. Since the air temperature exceeds the ignition temperature of the fuel, the fuel and air combust within combustion chamber 140 thereby releasing energy that drives piston assemblies 134 and 136 apart from the IDC position to the ODC position (typically referred to as the outward stroke of the two-stroke method). During the outward stroke, exhaust ports 142 are uncovered prior to air ports 138, thereby facilitating channeling exhaust gases from cylinder 130. Subsequently, air ports 138 are uncovered and the scavenging action described above is repeated. A similar method may be described for cylinder 132. The term “uniflow” is typically used to describe the substantially uniform direction of air and exhaust gas flow as described above.

The two-stroke action as described above is repeated substantially continuously in cylinders 130 and 132 with each cylinder being at a portion of the two-stroke cycle in direct opposition to the other cylinder. Piston assemblies 134 and 144 with their associated connecting rods 135 and 145, respectively drive the left hand side crankshaft. Similarly, piston assemblies 136 and 146 with their associated connecting rods 137 and 147, respectively drive the right hand side crankshaft. The two crankshafts drive their respective synchronized gears which drive the gear train and subsequently, drive assembly 108.

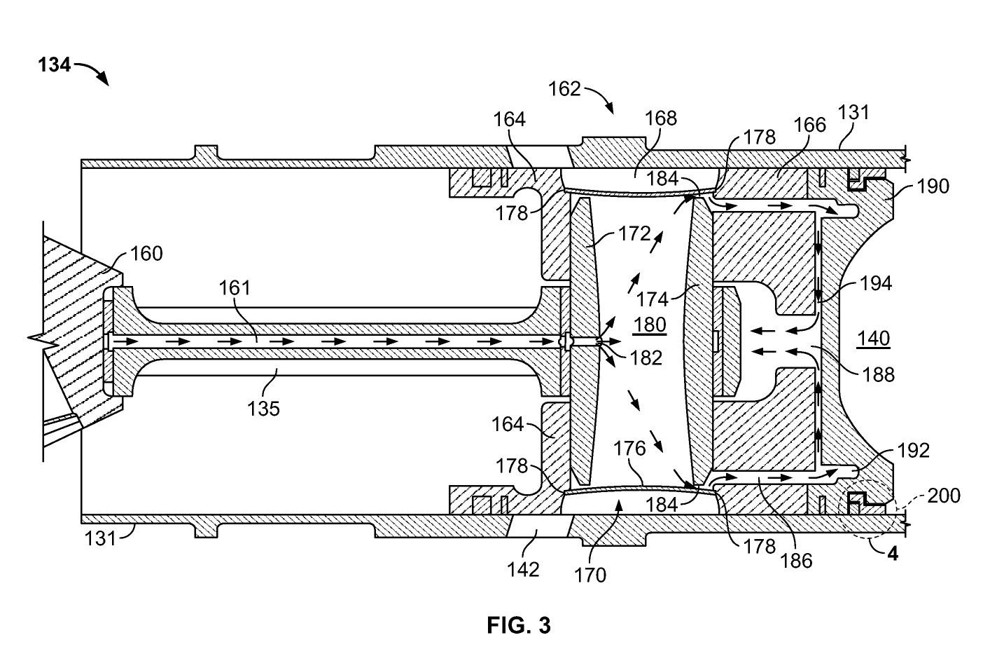

FIG. 3 is a cross-sectional schematic view of exemplary piston assembly 134 that may be used with internal combustion engine 100 (shown in FIGS. 1 and 2). Piston assemblies 136, 144 and 146 are substantially similar to piston assembly 134. Cylinder wall 131, combustion chamber 140 and exhaust port 142 are illustrated for perspective. Piston assembly 134 includes connecting rod 135 that is movably coupled to a left hand side crankshaft 160. Connecting rod 135 defines a substantially cylindrical fluid passage 161 that is coupled in flow communication to an oil pump via similar fluid passages (neither shown in FIG. 3) defined within crankshaft 160. Piston assembly 134 also includes a piston body 162. In the exemplary embodiment, piston body 162 is fabricated from aluminum via forging. Alternatively, piston body 162 is fabricated from any material via any method that facilitates attaining predetermined operational parameters of engine 100. At least some of these parameters include, but are not limited to, having wear and deformation resistant properties.

Piston body 162 includes an axially outer portion 164 and axially inner portion 166. Portions 164 and 166 are radially dimensioned such that a small tolerance is facilitated between portions 164 and 166 and cylinder wall 131. Portions 164 and 166 at least partially define a cross-passage 168 in cooperation with cylinder wall 131. Piston body 162 also includes a substantially hollow piston pin 170 that is received within cross-passage 168. Piston pin 170 includes a substantially circular axially outer segment 172, or bush 172, and a substantially circular axially inner segment 174. In one embodiment, piston pin segments 172 and 174 are fabricated from materials that include, but are not limited to, those materials substantially similar to and/or compatible with piston body 162. Piston pin segments 172 and 174 fabricated using methods that include, but are not limited to, casting and forging. Piston pin segment 172 is slidingly coupled to an axially inwardmost portion of connecting rod 135 by methods that include, but are not limited to, welding and brazing. Similarly, piston segment 174 is slidingly coupled to an axially outwardmost portion of piston body portion 166 by methods that include, but are not limited to welding and brazing.

Piston pin 170 further includes a substantially cylindrical sealing plug 176 fabricated from a material that has predetermined operational parameters. In one embodiment, such parameters include, but are not limited to, wear-resistance and heat resistance. Plug 176 is slidingly and removably coupled to piston body inner and outer segments 164 and 166, respectively via interference pressure fits within a plurality of substantially annular seats 178 defined within segments 164 and 166. During assembly of pin 170, a substantially cylindrical sealing plug 176 is inserted into seats 178 in a manner that facilitates forming a substantially radially inward concavity as well as inducing an axially outward expansion bias within plug 176.

Segments 172 and 174 and plug 176 define a piston pin bore 180 coupled in flow communication to connecting rod fluid passage 161 via a plurality of radial passages 182 formed within a center portion of segment 172. An axially innermost portion of plug 176 and a radially outermost portion of segment 174 define a substantially annular fluid passage 184 coupled in flow communication with bore 180. Piston body segment 166 includes a substantially annular fluid passage 186 that is coupled in flow communication to fluid passage 184. Moreover, a fluid return drain recess 188 is coupled in flow communication with a fluid reservoir (not shown in FIG. 3) within crankcase 104 (shown in FIG. 1). Recess 188 is also defined within segment 166.

Piston assembly 134 further includes a substantially circular piston crown 190. In the exemplary embodiment, piston crown 190 is fabricated from a high temperature resistant stainless steel alloy via forging. Alternatively, crown 190 is fabricated from any material via any method that facilitates attaining predetermined operational parameters of engine 100. At least some of these parameters include, but are not limited to, having wear and deformation resistant properties as well as having greater heat resistant properties than piston body 162. Crown 190 and piston body segment 166 are slidingly coupled together via retention hardware that includes, but is not limited to threaded fasteners (not shown in FIG. 3). Alternatively, body segment 166 and crown 190 are coupled via methods that include, but are not limited to, welding and brazing. A substantially annular fluid passage 192 that is coupled in flow communication with fluid passage 186 is defined within a radially outer portion of crown 190. Passage 192 is dimensioned to facilitate heat transfer from radially outer portions of crown 190 to a cooling fluid. An axially outermost portion of crown 190 and an axially innermost portion of segment 166 define a substantially circular fluid passage 194 that is coupled in flow communication with recess 188 and fluid passage 192. Passage 194 is dimensioned to facilitate attaining a predetermined fluid flow rate that subsequently facilitates attaining a predetermined rate of heat removal from radially outer portions of crown 190 to the cooling fluid.

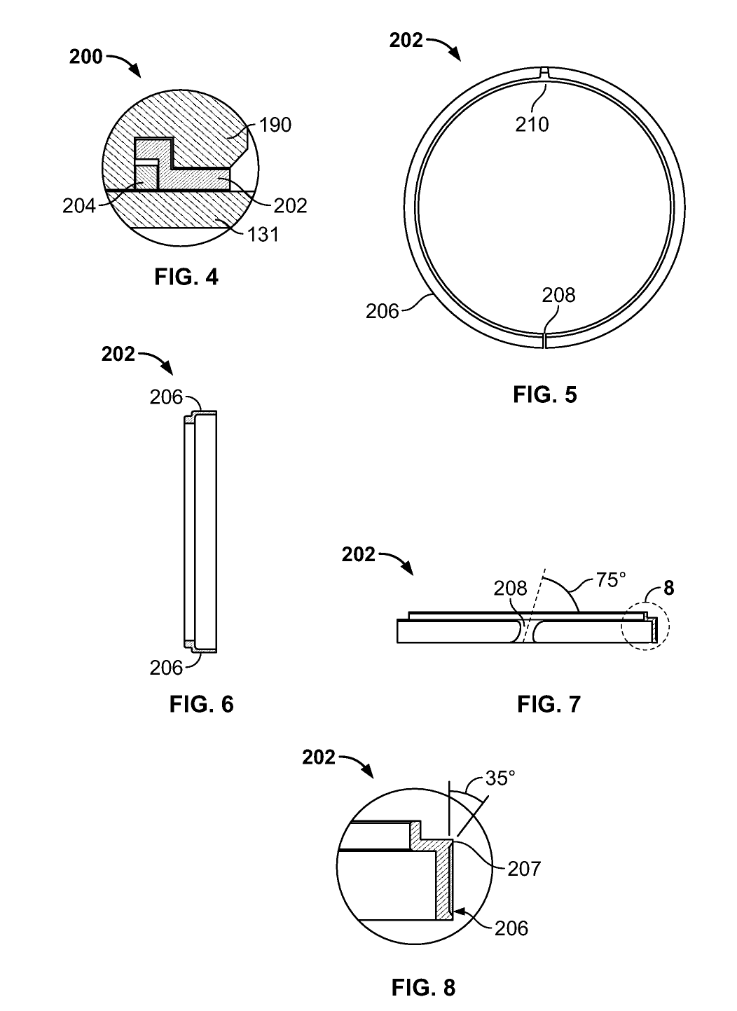

Crown 190 is radially dimensioned to facilitate a small tolerance between crown 190 and cylinder wall 131. Crown 190 is further dimensioned to receive a piston ring assembly 200 within a radial periphery of crown 190. Piston ring seal assembly 200 is illustrated within area 4 and is further illustrated in FIG. 4.

FIG. 4 is an expanded cross-sectional schematic view of exemplary piston ring assembly 200 taken along area 3 (shown in FIG. 3) that may be used with internal combustion engine 100 (shown in FIG. 1). Cylinder wall 131 and piston crown 190 are illustrated for perspective. Piston ring assembly 200 includes at least one fire ring 202 and at least one seal ring 204.

FIG. 5 is a cross-sectional schematic overhead view of exemplary fire ring 202 that may be used with piston ring assembly 200 (shown in FIG. 4). FIG. 6 is a cross-sectional schematic side view of exemplary fire ring 202 that may be used with piston ring assembly 200 (shown in FIG. 4). FIG. 7 is a cross-sectional schematic side view of an exemplary slit that may be defined within fire ring 202. FIG. 8 is an expanded cross-sectional schematic view of fire ring 202 taken along area 8 (shown in FIG. 7) that may be used with piston ring assembly 200 (shown in FIG. 4). FIGS. 4, 5, 6, 7 and 8 are referenced together for the discussion of fire ring 202.

Fire ring 202 includes a plurality of protrusions that facilitates fire ring 202 in attaining an approximate peripheral “z-shape”. In the exemplary embodiment, fire ring 202 is fabricated from a high temperature resistant, hardened and tempered stainless steel alloy via forging. Alternatively, fire ring 202 is fabricated from any material via any method that facilitates attaining predetermined operational parameters of engine 100. At least some of these parameters include, but are not limited to, fire ring 202 having wear, deformation resistant properties and heat resistant properties similar to crown 190. Fire ring 202 may also have conductive heat transfer properties that facilitate transferring heat from crown 190 to cylinder wall 131.

Fire ring 202 includes at least one heat and wear resistive layer 206 formed on a portion of fire ring 202 that is in contact with cylinder wall 131. In the exemplary embodiment, layer 206 is formed from materials that include, but are not limited to, molybdenum alloys. Fire ring 202 includes a protrusion 207 formed adjacent to layer 206. Protrusion 207 extends from layer 206 at approximately a 35° angle relative to a plane of layer 206. Protrusion 207 cooperates with layer 206 to form a seal between ring 202 and cylinder wall 131. A predetermined radial dimension of fire ring 202 (including layer 206) facilitates coupling fire ring 202 to crown 190 via an interference pressure fit. The predetermined radial dimension of fire ring 202 also facilitates maintaining the substantially circular shape of fire ring 202 by facilitating seal 202 conformance to the substantially circular shape of cylinder wall 131.

Fire ring 202 also includes a split 208 defined within ring 202 at a predetermined angle to a radial peripheral span of seal 202. Split 208 is circumferentially positioned to facilitate fire ring 202 avoidance of contact with a circumferential lip portion of cylinder wall 131 that defines a portion of at least one of exhaust ports 142 (shown in FIG. 3) as crown 190 axially travels past at least one exhaust port 142. This contact avoidance mitigates potential for damage to either ring 202 or cylinder wall 131 at exhaust port 142. In the exemplary embodiment, split 208 is positioned at approximately a 75° angle to a radial peripheral span of seal 202. Fire ring 202 further includes an indexing protrusion 210 that is positioned substantially circumferentially directly opposite split 206. Indexing protrusion 210 facilitates maintaining fire ring split 208 positioned substantially circumferentially opposite a similar split (not shown in FIGS. 4 through 8) within seal ring 204 (shown in FIG. 4) as discussed further below. This feature mitigates channeling of combustion gas exhaust from combustion chamber 140 (shown in FIG. 3) into portions of piston assembly 130 axially outboard of crown 190.

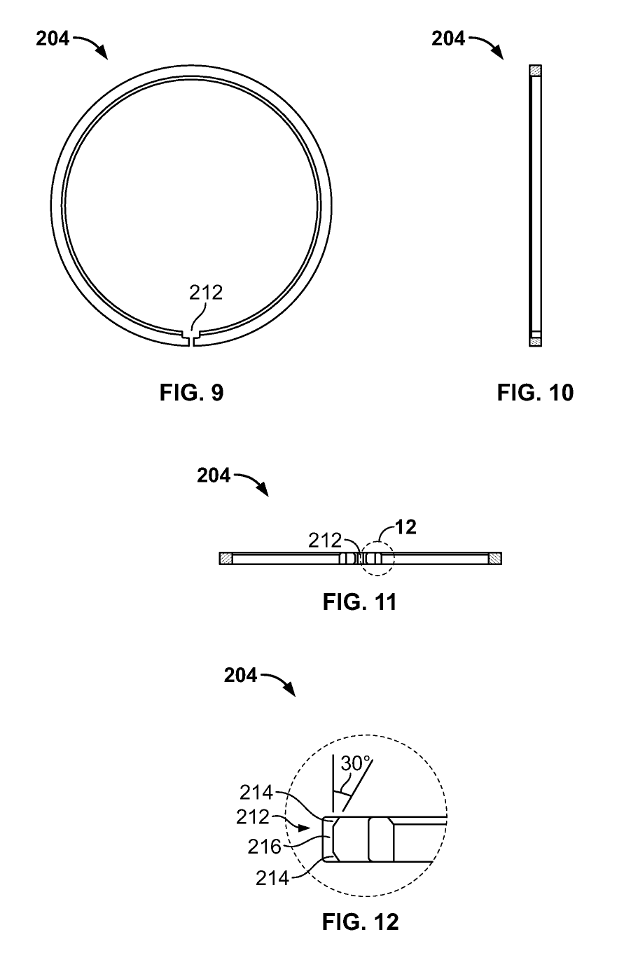

FIG. 9 is a cross-sectional schematic overhead view of exemplary seal ring 204 that may be used with piston ring assembly 200 (shown in FIG. 4). FIG. 10 is a cross-sectional schematic side view of exemplary seal ring 204 that may be used with piston ring assembly 200 (shown in FIG. 4). FIG. 11 is a cross-sectional schematic side view of an exemplary slit that may be defined within seal ring 204. FIG. 12 is an expanded cross-sectional schematic view of seal ring 204 taken along area 12 (shown in FIG. 11) that may be used with piston ring assembly 200 (shown in FIG. 4). FIGS. 4, 9, 10, 11 and 12 are referenced together for the discussion of seal ring 204.

In one embodiment, seal ring 204 is fabricated from any material via any method that facilitates attaining predetermined operational parameters of engine 100. At least some of these parameters include, but are not limited to seal ring 204 having wear, deformation resistant properties and heat resistant properties. Seal ring 204 also has conductive heat transfer properties that facilitate transferring heat from crown 190 to cylinder wall 131. In the exemplary embodiment, heat resistant properties of fire ring 202 are greater than those for seal ring 204. A predetermined radial dimension of seal ring 204 facilitates coupling seal ring 204 to crown 190 via an interference pressure fit. The predetermined radial dimension of fire ring 202 also facilitates maintaining the substantially circular shape of seal ring 204 by facilitating seal ring 204 conformance to the substantially circular shape of cylinder wall 131. Seal ring 204 has a substantially rectangular cross-section that facilitates ring 204 being positioned in ring assembly 200 such that it is directly adjacent to fire ring 202 and fire ring 202 extends over seal ring 204. The extension of fire ring 202 over seal ring 204 facilitates shielding of seal ring 204 from the high temperatures of combustion chamber 140 (shown in FIG. 3).

Seal ring 204 also includes a split 212 defined within ring 204 at a predetermined angle to a radial peripheral span of seal 204. Split 212 is circumferentially positioned to facilitate seal ring 204 avoiding contact with a circumferential lip portion of cylinder wall 131 that defines a portion of at least one exhaust port 142 (shown in FIG. 3) as crown 190 axially travels past at least one exhaust port 142. This contact avoidance mitigates potential for damage to either ring 204 or cylinder wall 131 at exhaust port 142. In the exemplary embodiment, split 212 includes two chamfered portions 214 on either side of an un-chamfered portion 216 for a total of four chamfered portions 214. Portions 214 are chamfered at approximately a 30° angle with respect to portion 216 to facilitate seal ring 204 avoiding contact with a circumferential lip portion of cylinder wall 131 as described above.

FIG. 3 is referenced during the following operational discussion. In operation, piston assembly 134 including body 164, pin 170, and crown 190 and seal assembly 200 travel in an axially reciprocating manner within cylinder 130 (shown in FIG. 2) and fuel and air are combusted within combustion chamber 140 as described above. As fuel is combusted and piston assembly 134 and seal ring assembly 200 slide against cylinder wall 131 generating heat due to friction, temperatures of piston assembly 134 and seal assembly 200 components increase.

Also, in operation, a cooling fluid is channeled from a reservoir via a pump to a fluid passage (neither shown in FIG. 3) within crankshaft 160. In the exemplary embodiment, the fluid is an engine oil. Alternatively, the cooling fluid may be any fluid that facilitates heat removal from engine 100 as described herein. Fluid is channeled from crankshaft 160 to connecting rod passage 161 as the arrows illustrate. Fluid is then channeled through radial openings 182 into piston pin bore 180 wherein the fluid is further channeled into passage 184. Fluid is then channeled from passage 184 into passage 186 wherein the fluid receives heat from radially outer portions of piston base 166. The fluid is further channeled to passage 192 wherein heat is received from radially outer portions of crown 190 and seal assembly 200. Fluid is subsequently channeled to passage 194 wherein a rate of heat transfer from crown 194 to the fluid decreases as the fluid travels radially inward through passage 194. This facilitates combustion by facilitating maintenance of higher temperatures within radially inner portions of crown 190 compared to those temperatures within radially outer portions of crown 190. The fluid is subsequently channeled to recess 188 and then crankcase 104 for cooling and subsequent recirculation through engine 100 as described above.

Further, during operation, fire ring 202 is exposed to high temperature combustion chamber 140. Fire ring 202 extends over seal ring 204, thereby mitigating exposure of seal ring 204 to the high temperature environment of combustion chamber 140. Moreover, fire ring 202 in cooperation with seal ring 204 and piston crown 190 mitigates exposure of piston assembly components axially outboard of crown 190 to the high temperature environment of combustion chamber 140.

The internal combustion engine described herein facilitates increasing the engine power-to-engine weight relationship. More specifically, such internal combustion engine includes piston and seal ring assemblies that facilitate cooling such engine effectively with fewer and lighter weight components. As a result, the life expectancy of components within internal combustion engines may be increased and the engines' capital and maintenance costs may be reduced.

The methods and apparatus for operating a piston assembly and a seal assembly described herein facilitates operation of an internal combustion engine. More specifically, the engine as described above facilitates a more efficient internal combustion engine configuration. Such engine configuration also facilitates efficiency, reliability, and reduced maintenance costs and fluid transport station outages.

Exemplary embodiments of piston and seal assemblies as associated with internal combustion engines are described above in detail. The methods, apparatus and systems are not limited to the specific embodiments described herein nor to the specific illustrated internal combustion engine.

While the invention has been described in terms of various specific embodiments, those skilled in the art will recognize that the invention can be practiced with modification within the spirit and scope of the claims.

What is claimed is:

1. A piston ring assembly for an internal combustion engine comprising a plurality of seal rings positioned on at least a portion of a piston crown periphery.

2. A piston ring assembly in accordance with claim 1 wherein said plurality of seal rings comprise a first seal ring and a second seal ring.

3. A piston ring assembly in accordance with claim 2 wherein said first seal ring comprises a high temperature and substantially wear resistant material.

4. A piston ring assembly in accordance with claim 3 wherein said wear resistant material comprises a stainless steel alloy.

5. A piston ring assembly in accordance with claim 2 wherein said first and second seal rings are positioned axially and radially adjacent to each other within said internal combustion engine, at least a portion of said first seal ring at least partially extends over at least a portion of said second seal ring.

6. A piston ring assembly in accordance with claim 2 wherein said first seal ring is substantially circular with a circumferential periphery and comprises at least one wall, said wall comprises at least one split defined within said wall, said wall defining at least one integral protrusion, said split extends obliquely at a predetermined angle to at least a portion of the circumferential periphery, said first seal ring positioned within said internal combustion engine such that said first seal ring split is positioned with substantially circumferential opposition to a second seal ring split defined within said second seal ring, said first seal ring split facilitates contact avoidance between said first seal ring and at least a portion of at least one exhaust port, said integral protrusion facilitates substantially circumferential opposition between said first seal ring split and the second seal ring split.

7. A piston ring assembly in accordance with claim 6 wherein said seal ring wall comprises a substantially wear resistant material layer extending over at least a portion of said seal ring wall.

8. A piston ring assembly in accordance with claim 7 wherein said wear resistant material layer comprises a molybdenum alloy.

9. A piston ring assembly in accordance with claim 2 wherein said second seal ring is substantially circular with a circumferential periphery and comprises at least one wall having at least one split defined therein, said wall defines a substantially rectangular circumferential profile, said split extends obliquely at a predetermined angle to at least a portion of the circumferential periphery, said second seal ring positioned within said internal combustion engine such that said second seal ring split positioned with substantially circumferential opposition to a first seal ring split defined within said first seal ring, said second seal ring split facilitates contact avoidance between said second seal ring and at least a portion of at least one exhaust port.

10. A method of operating an internal combustion engine comprising positioning a piston ring assembly on at least a portion of a piston crown periphery, said positioning a piston ring assembly comprises positioning a first seal ring and a second seal ring such that the first seal ring is a first axial distance from the combustion chamber and the second seal ring is a second axial distance from the combustion chamber, the second distance is greater than the first distance, the first seal ring comprising a high temperature material.

11. A method of operating an internal combustion engine in accordance with claim 10 wherein positioning a first seal ring comprises positioning the first seal ring on at least a portion of the piston crown periphery such that the first seal ring is coupled to the portion of the piston crown via an interference fit.

12. A method of operating an internal combustion engine in accordance with claim 10 wherein positioning a first seal ring and a second seal ring comprises positioning the first and second seal rings within the internal combustion engine such that a first seal ring split is positioned with substantially circumferential opposition to a second seal ring split.

13. An internal combustion engine comprising:
at least one substantially cylindrical housing; and
a plurality of opposed piston assemblies enclosed within said cylindrical housing, said plurality of opposed piston assemblies comprising a plurality of seal rings, said seal rings positioned on at least a portion of a piston crown periphery.

14. An engine in accordance with claim 13 wherein said plurality of seal rings comprise a first seal ring and a second seal ring.

15. An engine in accordance with claim 14 wherein said first seal ring comprises a high temperature and substantially wear resistant material.

16. An engine in accordance with claim 15 wherein said wear resistant material comprises a stainless steel alloy.

17. An engine in accordance with claim 14 wherein said first and second seal rings are positioned axially and radially adjacent to each other within said diesel engine, at least a portion of said first seal ring at least partially extends over at least a portion of said second seal ring.

18. An engine in accordance with claim 14 wherein said first seal ring is substantially circular with a circumferential periphery and comprises at least one wall, said wall comprises at least one split defined within said wall, said wall defining at least one integral protrusion, said split extends obliquely at a predetermined angle to at least a portion of the circumferential periphery, said first seal ring positioned within said diesel engine such that said first seal ring split is positioned with substantially circumferential opposition to a second seal ring split defined within said second seal ring, said first seal ring split facilitates contact avoidance between said first seal ring and at least a portion of at least one exhaust port, said at least one integral protrusion facilitates substantially circumferential opposition between said first seal ring split and the second seal ring split.

19. An engine in accordance with claim 18 wherein said seal ring wall comprises a substantially wear resistant material layer extending over at least a portion of said seal ring wall.

20. An engine in accordance with claim 14 wherein said second seal ring is substantially circular with a circumferential periphery and comprises at least one wall, said wall comprises at least one split defined within said wall, said wall defines a substantially rectangular circumferential profile, said split extends obliquely at a predetermined angle to at least a portion of the circumferential periphery, said second seal ring is positioned within said diesel engine such that said second seal ring split is positioned with substantially circumferential opposition to a first seal ring split defined within said first seal ring, said second seal ring split facilitates contact avoidance between said second seal ring and at least a portion of at least one exhaust port.
